(19) United States
(12) Patent Application Publication
(10) Pub. No.: US 2022/0198500 A1
(43) Pub. Date: Jun. 23, 2022

(54) METHOD AND TRANSACTION PLATFORM FOR INCENTIVES OF BLOCKCHAIN

(71) Applicant: Bin WANG, Shanghai (CN)

(72) Inventor: Bin WANG, Shanghai (CN)

(21) Appl. No.: 17/244,597

(22) Filed: Apr. 29, 2021

(30) Foreign Application Priority Data
Dec. 22, 2020 (CN) 2020115331337

(51) Int. Cl. G06Q 30/02; G06Q 40/04; H04L 9/32

(52) U.S. Cl. CPC G06Q 30/0215; H04L 2209/56; H04L 9/3213; G06Q 40/04

(57) ABSTRACT

The present disclosure discloses a method for incentives and a transaction platform of a blockchain. The method of the present disclosure includes: monitoring liquidity of the blockchain in real time, the liquidity being the number of assets in a bonus pool; decreasing an incentive according to a countervailing incentive model when the liquidity increases, the sum of the liquidity and the incentive being always kept unchanged in the countervailing incentive model; and increasing the incentive according to the countervailing incentive model when the liquidity decreases. The present disclosure is intended to solve a problem of vicious cycle of a blockchain, which is caused by an existing method for block incentive allocation in a blockchain.

### FIELD OF THE INVENTION

The present disclosure relates to the technical field of blockchain, and more particularly, to a method and a transaction platform for incentives of a blockchain.

### BACKGROUND OF THE INVENTION

In the application of blockchains, there are many reward methods for blocks. For example, Bitcoin (BTC) and Ethereum (ETH) both decay by half according to the period of time until a constant amount is reached. In some other reward methods, no decay occurs, and there are always the same rewards. Block rewards are provided for blockchain stakers to encourage the stakers to make transactions and block proofs, with the goal of achieving a good ecological restriction. However, in the existing blockchain liquidity incentive allocation methods, there often exists a problem of a proportion between incentive time and user input. That is, the longer the time is, either the larger the bubbles are, or the fewer the incentives are due to half decay, and the fewer the stakers are. As a result, this problem leads to disability of the whole incentive model after a long-time operation. As users' participation enthusiasm is reduced, a vicious cycle of the blockchains may be caused.

### SUMMARY OF THE INVENTION

A major objective of the present disclosure is to provide a method for incentives and a transaction platform of a blockchain to solve the problem of vicious cycle of the blockchain caused by the existing block incentive allocation methods of blockchains.

To achieve the above objective, in a first aspect of the present disclosure, there is provided a method for incentives of a blockchain.

The method for incentives of a blockchain according to the present disclosure includes:

monitoring liquidity of the blockchain in real time, the liquidity being the number of assets in a bonus pool;

decreasing an incentive according to a countervailing incentive model when the liquidity increases, a sum of the liquidity and the incentive being always kept unchanged in the countervailing incentive model; and

increasing the incentive according to the countervailing incentive model when the liquidity decreases.

Alternatively, said decreasing an incentive according to a countervailing incentive model when the liquidity increases includes:

decreasing the number of liquidity incentive tokens allocated by each block by a first differential and increasing a buyback proportion of a service charge for a successful transaction by a second differential each time the liquidity increases by a rated value.

Alternatively, said increasing the incentive according to the countervailing incentive model when the liquidity decreases includes:

increasing the number of the liquidity incentive tokens allocated by each block by the first differential and decreasing the buyback proportion of the service charge for the successful transaction by the second differential each time the liquidity decreases by the rated value.

Alternatively, in the process of decreasing an incentive according to a countervailing incentive model when the liquidity increases, the method further includes:

determining whether a current liquidity is greater than a first threshold; and

stopping decreasing the incentive according to the countervailing incentive model and increasing the incentive according to the countervailing incentive model in response to the current liquidity being greater than the first threshold.

Alternatively, in the process of increasing the incentive according to the countervailing incentive model when the liquidity decreases, the method further includes:

determining whether a current liquidity is less than a second threshold; and

stopping increasing the incentive according to the countervailing incentive model and decreasing the incentive according to the countervailing incentive model in response to the current liquidity being less than the second threshold.

Alternatively, the countervailing incentive model includes a plurality of modes where:

the number of liquidity incentive tokens allocated by each block decreases by the first differential and the buyback proportion of the service charge for the successful transaction increases by the second differential from the first mode to the last mode.

Alternatively, the method further includes:

executing an incentive in a forward and backward cross-circulation manner according to an arrangement order of the plurality of modes as the number of blocks increases.

Alternatively, the method further includes:

invoking a contract interface by a robot to complete buyback and destruction operations in a first predetermined time period, and allocating a token to a blockchain liquidity staker in a second predetermined time period.

To achieve the above objective, in a second aspect of the present disclosure, there is provided a transaction platform, including at least one server configured to perform the method for incentives of a blockchain according to any one embodiment in the first aspect.

To achieve the above objective, in a third aspect of the present disclosure, there is provided a computer-readable storage medium storing computer instructions causing a computer to perform the method for incentives of a blockchain according to any one embodiment in the first aspect.

In the method and the transaction platform for incentives of a blockchain provided by the embodiments of the present disclosure, the method includes: monitoring liquidity of the blockchain in real time, wherein the liquidity is the number of assets in a bonus pool; decreasing an incentive according to a countervailing incentive model when the liquidity increases, wherein the sum of the liquidity and the incentive is always kept unchanged in the countervailing incentive model; and increasing the incentive according to the countervailing incentive model when the liquidity decreases. As can be seen in the present disclosure, in block rewards of the blockchain, the incentive is dynamically adjusted according to the liquidity. That is, the incentive is increased when the liquidity decreases; and the rewards are decreased when the liquidity increases. This method is a method for cyclic variable countervailing incentive, where the liquidity is inversely proportional to the rewards. This mode is a variable ecological countervailing mode, which can effectively solve the problem of vicious cycle in an existing method for block incentive.

### BRIEF DESCRIPTION OF THE DRAWINGS

The accompanying drawings constituting a part of the present disclosure are intended for providing further understanding of the present disclosure, such that other features, objectives and advantages of the present disclosure become more apparent. The accompanying drawings for exemplary embodiments of the present disclosure and description thereof are intended for explaining the present disclosure, and not for constituting an improper limitation on the present disclosure. In the accompanying drawings:

FIG. 1 is a flowchart of a method for incentives of a blockchain according to an embodiment of the present disclosure.

### DETAILED DESCRIPTION OF THE EMBODIMENTS

To make a person skilled in the art better understand the solutions of the present disclosure, technical solutions in the embodiments of the present disclosure will be described clearly and completely below with reference to the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

It should be explained that in the description, the claims and the foregoing accompanying drawings of the present disclosure, a term (such as a first or a second . . . . . . ) is intended to separate between similar objects but is not intended to describe a specific sequence or precedence order. It is to be understood that data used like this may be interchangeable where appropriate, such that the embodiments of the present disclosure may be described herein. Furthermore, terms such as “comprise”, “have” or other variants thereof are intended to cover a non-exclusive “comprise”, for example, processes, methods, systems, products or devices comprising a series of steps or units are not limited to these steps or units listed explicitly, but comprise other steps or units not listed explicitly, or other steps or units inherent to these processes, methods, systems, products or devices.

It should also be noted that the embodiments in the present disclosure and the features in the embodiments may be combined with each other on a non-conflict basis. The present disclosure will be described below in detail with reference to the accompanying drawings and in combination with the embodiments.

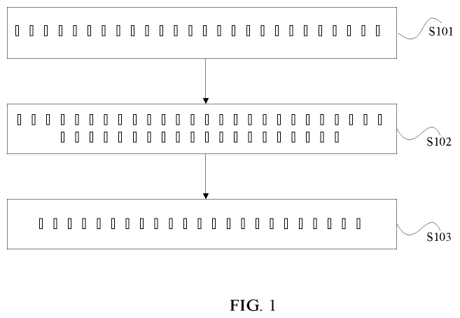

According to the embodiments of the present disclosure, there is provided a method for incentives of a blockchain, and the embodiments are used in a blockchain transaction platform. As shown in FIG. 1, the method includes following steps.

In Step S101, liquidity of the blockchain is monitored in real time, wherein the liquidity is the number of assets in a bonus pool.

In Step S102, an incentive is decreased according to a countervailing incentive model when the liquidity increases, and the sum of the liquidity and the incentive is always kept unchanged in the countervailing incentive model.

Specifically, said decreasing an incentive according to a countervailing incentive model when the liquidity increases includes: decreasing the number of liquidity incentive tokens allocated by each block by a first differential and increasing a buyback proportion of a service charge for a successful transaction by a second differential each time the liquidity increases by a rated value. The first differential and the second differential may be set upon actual demands. For example, the first differential may be one token, and the second differential may be 10%. The token is a token. The rated value may be each additional 10,000 blocks increased or 11,000 increased in total yield.

Furthermore, in the process of said decreasing an incentive according to a countervailing incentive model when the liquidity increases, the method further includes:

determining whether a current liquidity is greater than a first threshold; and

stopping decreasing the incentive according to the countervailing incentive model and increasing the incentive according to the countervailing incentive model (i.e., said increasing the incentive according to the countervailing incentive model in Step S103 is performed) when the current liquidity is greater than the first threshold.

In Step S103, the incentive is increased according to the countervailing incentive model when the liquidity decreases.

Specifically, said increasing the incentive according to the countervailing incentive model when the liquidity decreases includes: increasing the number of the liquidity incentive tokens allocated by each block by the first differential and decreasing the buyback proportion of the service charge for the successful transaction by the second differential each time the liquidity decreases by the rated value.

Furthermore, in the process of increasing the incentive according to the countervailing incentive model when the liquidity decreases, the method further includes:

determining whether a current liquidity is less than a second threshold; and

stopping increasing the incentive according to the countervailing incentive model and decreasing the incentive according to the countervailing incentive model when the current liquidity is less than the second threshold.

In addition, it is to be noted that the first threshold in Step S102 and the second threshold in Step S103 may be set upon actual demands. For example, the first threshold may be set as 99,000 Bitcoins in the total yield, and the second threshold may be set as 11,000 Bitcoins in the total yield.

Furthermore, the transaction platform invokes a contract interface by a robot to complete buyback and destruction operations in a first predetermined time period, and allocates a token to a blockchain liquidity staker in a second predetermined time period. The first predetermined time period and the second predetermined time period may be set upon actual demands. For example, the first predetermined time period and the second predetermined time period may be set as one day or two days, etc.

In addition, the countervailing incentive model may include a plurality of modes. The number of liquidity incentive tokens allocated by each block decreases by the first differential and the buyback proportion of the service charge for the successful transaction increases by the second differential from the first mode to the last mode. Correspondingly, according to the incentive method, as the number of blocks increases, an incentive is executed in a forward and backward cross-circulation manner according to an arrangement order of the plurality of modes. A specific example is given for explanation. Assuming that the countervailing incentive model includes six modes, which are arranged in order as below: Mode 1, Mode 2, Mode 3, Mode 4, Mode 5, and Mode 6. The incentive is executed in the forward and backward cross-circulation manner as below: “Mode 1, Mode 2, Mode 3, Mode 4, Mode 5, Mode 6, Mode 5, Mode 4, Mode 3, Mode 2, Mode 1, Mode 2, Mode 3, and so on”.

As can be seen from the above description, according to the method for incentives of a blockchain provided by the embodiments of the present disclosure, liquidity of the blockchain is monitored in real time, wherein the liquidity is the number of assets in a bonus pool. An incentive is decreased according to a countervailing incentive model when the liquidity increases, wherein the sum of the liquidity and the incentive is always kept unchanged in the countervailing incentive model. The incentive is increased according to the countervailing incentive model when the liquidity decreases. As can be seen in the present disclosure, in block rewards of the blockchain, the incentive is dynamically adjusted according to the liquidity. That is, the incentive is increased when the liquidity decreases; and the rewards are decreased when the liquidity increases. This method is a method of cyclic variable countervailing incentive, where the liquidity is inversely proportional to the rewards. This mode is a variable ecological countervailing mode, which can effectively solve the problem of vicious cycle in an existing method for block incentive.

A specific example is given to explain the method for incentives of a blockchain provided by the above embodiments.

In the allocation of liquidity mining incentives, liquidity mining providers and equity stakers are released for all transaction pairs based on allocations of each block, and meanwhile a buyback proportion accounting for 0.05% of a service charge associated with each block period is set. The buyback represents buyback and destruction operations completed by invoking a contract interface by a robot in a certain time period (such as once a day), and stakes are also allocated in a certain time period (such as once a day).

In the first period (the first 10,000 blocks or 99,000 Bitcoins are limited): nine tokens are allocated as liquidity rewards to each block, and comparably 10% of the nine tokens (i.e., 0.9 token) is additionally mined for all the stakers, with a total yield of 99,000 Bitcoins. In this period, 10% of 0.05% of all the service charges is accumulated to a buyback capital pool.

In the second period (the second 10,000 blocks or 88,000 Bitcoins are limited): eight tokens are allocated as liquidity rewards to each block, and comparably 10% of the eight tokens (i.e., 0.8 token) is additionally mined for all the stakers, with a total yield of 88,000 Bitcoins. In this period, 20% of 0.05% of all the service charges is accumulated to the buyback capital pool.

In the third period (the third 10,000 blocks or 77,000 Bitcoins are limited): seven tokens are allocated as liquidity rewards to each block, and comparably 10% of the seven tokens (i.e., 0.7 token) is additionally mined for all the stakers, with a total yield of 77,000 Bitcoins. In this period, 30% of 0.05% of all the service charges is accumulated to the buyback capital pool.

In the fourth period (the fourth 10,000 blocks or 66,000 Bitcoins are limited): six tokens are allocated as liquidity rewards to each block, and comparably 10% of the six tokens (i.e., 0.6 token) is additionally mined for all the stakers, with a total yield of 66,000 Bitcoins. In this period, 40% of 0.05% of all the service charges is accumulated to the buyback capital pool.

In the fifth period (the fifth 10,000 blocks or 55,000 Bitcoins are limited): five tokens are allocated as liquidity rewards to each block, and comparably 10% of the five tokens (i.e., 0.5 token) is additionally mined for all the stakers, with a total yield of 55,000 Bitcoins. In this period, 50% of 0.05% of all the service charges is accumulated to the buyback capital pool.

In the sixth period (the sixth 10,000 blocks or 44,000 Bitcoins are limited): four tokens are allocated as liquidity rewards to each block, and comparably 10% of the four tokens (i.e., 0.4 token) is additionally mined for all the stakers, with a total yield of 44,000 Bitcoins. In this period, 60% of 0.05% of all the service charges is accumulated to the buyback capital pool.

In the seventh period (the seventh 10,000 blocks or 33,000 Bitcoins are limited): three tokens are allocated as liquidity rewards to each block, and comparably 10% of the three tokens (i.e., 0.3 token) is additionally mined for all the stakers, with a total yield of 33,000 Bitcoins. In this period, 70% of 0.05% of all the service charges is accumulated to the buyback capital pool.

In the eighth period (the eighth 10,000 blocks or 22,000 Bitcoins are limited): two tokens are allocated as liquidity rewards to each block, and comparably 10% of the two tokens (i.e., 0.2 token) is additionally mined for all the stakers, with a total yield of 22,000 Bitcoins. In this period, 80% of 0.05% of all the service charges is accumulated to the buyback capital pool.

In the ninth period (the ninth 10,000 blocks or 11,000 Bitcoins are limited): one token is allocated as a liquidity reward to each block, and comparably 10% of the one token (i.e., 0.1 token) is additionally mined for all the stakers, with a total yield of 11,000 Bitcoins. In this period, 90% of 0.05% of all the service charges is accumulated to the buyback capital pool.

In the tenth period (the tenth 10,000 blocks or 22,000 Bitcoins are limited): two tokens are allocated as liquidity rewards to each block, and comparably 10% of the two tokens (i.e., 0.2 token) is additionally mined for all the stakers, with a total yield of 22,000 Bitcoins. In this period, 80% of 0.05% of all the service charges is accumulated to the buyback capital pool.

The above periods are cycled in turn.

In the above example, the first period to the ninth period correspond to the plurality of modes in the countervailing incentive model in the above embodiments. Starting from the tenth period, it returns to the mode in the eighth period where the liquidity rewards and the buyback proportion are allocated to each block. It is to be noted that the corresponding relationship between the above example and the embodiment in FIG. 1 is as follows: the first differential is one token, the second differential is 10%, the first threshold is 99,000 Bitcoins in total yield, the second threshold is 11,000 Bitcoins in total yield, the liquidity is the total yield, the percentage (10%, 20%, 30%, 40%, 50%, 60%, 70%, 80%, and 90%) of 0.05% of the service charges is the buyback proportion in the service charges for successful transactions.

In addition, the rewards for each miner may be calculated based on the following rules.

The number of rewards for each block providing liquidity by the miner in a certain transaction pair=(the amount of liquidities provided in this transaction pair/the sum of the liquidities provided to all miners in this transaction pair)*(the block reward weight index of this transaction pair/weight indexes of all transaction pairs)*the total number of current rewards for each block.

It is to be explained that the steps illustrated in the flowchart of the accompanying drawings may be executed by a computer system such as a set of computer-executable instructions. A logic sequence is illustrated in the flowchart, but in some cases the illustrated or described steps may be executed in a sequence different from the sequence herein.

According to the embodiments of the present disclosure, there is further provided a transaction platform for implementing the method as shown in FIG. 1. The platform includes at least one server configured to perform the method for incentives of a blockchain as shown in FIG. 1. Specific processes of implementation may include: monitoring liquidity of the blockchain in real time, the liquidity being the number of assets in a bonus pool; decreasing an incentive according to a countervailing incentive model when the liquidity increases, the sum of the liquidity and the incentive being always kept unchanged in the countervailing incentive model; and increasing the incentive according to the countervailing incentive model when the liquidity decreases.

As can be seen from the above description, in the embodiments of the present disclosure, liquidity of the blockchain is monitored in real time, wherein the liquidity is the number of assets in a bonus pool. An incentive is decreased according to a countervailing incentive model when the liquidity increases, wherein the sum of the liquidity and the incentive is always kept unchanged in the countervailing incentive model. The incentive is increased according to the countervailing incentive model when the liquidity decreases. As can be seen in the present disclosure, in block rewards of the blockchain, the incentive is dynamically adjusted according to the liquidity. That is, the incentive is increased when the liquidity decreases; and the rewards are decreased when the liquidity increases. This method is a method of cyclic variable countervailing incentive, where the liquidity is inversely proportional to the rewards. This mode is a variable ecological countervailing mode, which can effectively solve the problem of vicious cycle in an existing method for block incentive.

According to the embodiments of the present disclosure, there is further provided a computer-readable storage medium storing computer instructions for causing a computer to perform the method for incentives of a blockchain in the above method embodiments. The storage medium may include: a read-only memory (ROM), a random access memory (RAM), a magnetic disk or an optical disk, etc. A computer program is stored on the storage medium, and the computer program is loaded by a processor to perform the steps in the method for incentives of a blockchain provided by any one of the embodiments of the present disclosure. For example, the computer program is loaded by the processor to monitor liquidity of the blockchain in real time, wherein the liquidity is the number of assets in a bonus pool;

to decrease an incentive according to a countervailing incentive model when the liquidity increases, wherein a sum of the liquidity and the incentive is always kept unchanged in the countervailing incentive model; and

to increase the incentive according to the countervailing incentive model when the liquidity decreases.

Apparently, those skilled in the art should understand that each of the foregoing modules or steps of the present disclosure may be implemented with general computing devices, they may be concentrated on a single computing device, or distributed in a network constituted by a plurality of computing devices, and optionally they may be implemented with program codes executable by computing devices, thereby they may be stored in storage devices and executed by computing devices, or they may be made into IC modules, or a plurality of modules or steps among them are made into a single IC module. In this way, the present disclosure is not limited to the combination of any specific hardware and software.

The above embodiments are merely preferred embodiments of the present disclosure and are not intended to limit the present disclosure. To those skilled in the art, the present disclosure may have various modifications and changes. All modifications, equivalent substitutions and improvements made within the spirit and principle of the present disclosure shall fall within the protection scope of the present disclosure.

1. A method for incentives of a blockchain, comprising:
monitoring liquidity of the blockchain in real time, the liquidity being the number of assets in a bonus pool;
decreasing an incentive according to a countervailing incentive model when the liquidity increases, a sum of the liquidity and the incentive being always kept unchanged in the countervailing incentive model; and
increasing the incentive according to the countervailing incentive model when the liquidity decreases.

2. The method for incentives of a blockchain according to claim 1, wherein said decreasing an incentive according to a countervailing incentive model when the liquidity increases comprises:
decreasing the number of liquidity incentive tokens allocated by each block by a first differential and increasing a buyback proportion of a service charge for a successful transaction by a second differential each time the liquidity increases by a rated value.

3. The method for incentives of a blockchain according to claim 2, wherein said increasing the incentive according to the countervailing incentive model when the liquidity decreases comprises:
increasing the number of the liquidity incentive tokens allocated by each block by the first differential and decreasing the buyback proportion of the service charge for the successful transaction by the second differential each time the liquidity decreases by the rated value.

4. The method for incentives of a blockchain according to claim 3, wherein in the process of decreasing an incentive according to a countervailing incentive model when the liquidity increases, the method further comprises:
determining whether a current liquidity is greater than a first threshold; and
stopping decreasing the incentive according to the countervailing incentive model and increasing the incentive according to the countervailing incentive model in response to the current liquidity being greater than the first threshold.

5. The method for incentives of a blockchain according to claim 3, wherein in the process of said increasing the incentive according to the countervailing incentive model when the liquidity decreases, the method further comprises:
determining whether a current liquidity is less than a second threshold; and
stopping increasing the incentive according to the countervailing incentive model and decreasing the incentive according to the countervailing incentive model in response to the current liquidity being less than the second threshold.

6. The method for incentives of a blockchain according to claim 2, wherein the countervailing incentive model comprises a plurality of modes:
the number of liquidity incentive tokens allocated by each block decreasing by the first differential and the buyback proportion of the service charge for the successful transaction increasing by the second differential from the first mode to the last mode.

7. The method for incentives of a blockchain according to claim 6, further comprising:
executing an incentive in a forward and backward cross-circulation manner according to an arrangement order of the plurality of modes as the number of blocks increases.

8. The method for incentives of a blockchain according to claim 1, further comprising:
invoking a contract interface by a robot to complete buyback and destruction operations in a first predetermined time period, and allocating a token to a blockchain liquidity staker in a second predetermined time period.

9. A transaction platform, comprising at least one server configured to perform the method for incentives of a blockchain according to claim 1.

10. A computer-readable storage medium, storing computer instructions causing a computer to perform the method for incentives of a blockchain according to claim 1.
